(19) United States
(12) Patent Application Publication
(10) Pub. No.: US 2007/0084128 A1
(43) Pub. Date: Apr. 19, 2007

(54) Restraint system for vehicle occupants

(76) Inventors: Rolf-Juergen Recknagel, Jena (DE); Matthias Wellhoefer, Stuttgart (DE)

Correspondence Address: KENYON & KENYON LLP, ONE BROADWAY, NEW YORK, NY, 10004, US

(21) Appl. No.: 10/576,681

(22) PCT Filed: Jul. 22, 2004
(86) PCT No.: PCT/DE04/01599

§ 371 Date: Apr. 21, 2006

(30) Foreign Application Priority Data
Oct. 23, 2003 (DE) 103 49 209.7

(51) Int. Cl. B60J 5/04

(52) U.S. Cl. 49/502

(57) ABSTRACT

A restraint system for vehicle occupants includes a restraint device, a control unit for controlling the restraint device, and at least one pressure sensor situated in a peripheral region of a vehicle. The restraint system also includes at least one position sensor for measuring the position of at least one movable part of the vehicle. The output signal from the position sensor may be combined with the output signal from the pressure sensor.

### FIELD OF THE INVENTION

The present invention relates to a restraint system for vehicle occupants.

### BACKGROUND INFORMATION

Highway traffic in densely populated areas has resulted in the endangerment of vehicles and vehicle occupants from side impacts (side crashes). Side impacts are associated with a high risk of injury to the occupants, since only a comparatively short crumple zone is available, and the time for recognizing a hazard and the subsequent activation of restraining means is extremely brief. For the recognition of side impacts, pressure sensors are preferably used which detect the pressure in the interior of a vehicle part. For example, the pressure in a cavity enclosed by the doors of the vehicle may be measured. Such pressure sensors detect non-critical, slow pressure changes during normal vehicle operation which arise, for example, as the result of weather effects or traveling on roads with varying elevations. The pressure sensors also detect a rapid pressure rise caused by an impact (by quasi-adiabatic compression). To enable such a rapid pressure rise to be detected without the influence of weather- or elevation-related pressure changes, normalization is performed based on the prevailing ambient pressure. In this manner a measured value which is approximately proportional to the crash speed can be deduced from the signal from the pressure sensor. Unfortunately, this measured value is not reliable enough to also be used as a criterion for a side impact, since the value is subject to great fluctuations. Impact tests using pendulums and the results of crash tests have shown that the position of the window panes of the vehicle have a considerable influence on this measured value, and may even distort this value so greatly that it is no longer possible to reliably detect a side impact. Practical test results indicate that the amplitude of the output signal from the pressure sensor is approximately 10% to 20% less for a completely open window pane than for a closed window pane. The reason for this may be, for example, that for a completely lowered window pane an open gap is formed in the region of the sealing lip, which represents a non-tight location and thereby modifies the polytropic exponent. This has the disadvantageous consequence that such a high amplitude value is no longer reached when the pressure rises as the result of a side impact. Furthermore, the lowered window pane may cover the pressure inlet opening of the pressure sensor, causing the direct pressure wave to be damped by the window pane. This unfavorable effect on the output signal from the pressure sensor depends on numerous parameters, such as for example the geometric dimensions of the door, volume of the door, leak-tightness of the door, shape and size of the window panes, design and age of the sealing lips, and position of the window pane in the door. As a disadvantageous consequence, problems arise in the recognition of a side impact. If a window is partly or completely open, a significantly lower amplitude for a pressure rise is expected. As a result, it is not possible to reach a predetermined threshold value for the deployment of lateral restraining means until a later point in time. However, due to the previously described problems with a side impact it is extremely important for the safety of the occupants that a risk evaluation be performed as early as possible to enable a decision to be made for the activation of restraining means. The risk to the occupants may increase dramatically for each millisecond that this critical decision is delayed. In the limiting case, a pressure signal which represents the least severe non-deployment crash may even be reduced because of a lowered window to such an extent that within the application tolerance the pressure signal can no longer be reliably distinguished from the signal of the most severe non-deployment crash. The pressure signal generated from, for example, an impact with a deformable barrier at a speed of approximately 29 km/h represents a least severe non-deployment crash. The pressure signal generated from an impact with a deformable barrier at a speed of approximately 19 km/h represents a most severe non-deployment crash. Thus, as a function the design of the vehicle, in particular the design of the vehicle door, a gray zone around the deployment threshold may result in which the restraining means provided for lateral protection may be expected to have an undefined response. Not only the amplitude, but also the full width of half maximum of the pressure signal may be reduced, since pressure is equalized with the surroundings more rapidly on account of the non-tight position. This also has a disadvantageous effect on the ability to recognize a side impact.

A device for attachment to a vehicle door is described in German Patent Application No. DE 101 06 311 A1, which in a housing contains components of a drive for raising and lowering a vehicle window pane and components of a sensor unit for recognizing an impact. The device also includes a GMR sensor for measuring the rotational speed of an electric motor for the drive, which makes it possible to indirectly detect the position of an articulated drive and the position of the window pane. The position of the window pane is evaluated for an anti-jamming system.

### SUMMARY

The output signal from a pressure sensor which is provided for a pressure measurement and used for recognizing a side impact to the vehicle is greatly dependent on the position of a movable vehicle part, such as in particular a window pane provided in a vehicle door. Depending on the position of the movable vehicle part, both the amplitude and the shape of the output signal from the pressure sensor may be disadvantageously modified in such a way that it is no longer possible to evaluate the output signal from the pressure sensor quickly enough or with sufficient accuracy to be able to respond to a critical accident situation in a timely manner. This disadvantage may be avoided by a restraint system according to an example embodiment of the present invention. According to the present invention, it may be possible to accurately recognize a side impact by use of a pressure sensor, practically independently of the position of a movable part of the vehicle, such as a window in particular. A further advantage may be that for the calibration of a pressure sensor provided for recognizing a side impact, the possibility of a diminished signal as a result of the position of the adjustable vehicle part no longer must be taken into account by using an additional amplitude tolerance for the signal from the pressure sensor. A more accurate calibration is thus possible, and the deployment times remain guaranteed even in the field, since an adjustable vehicle part, such as an open window in particular, no longer results in a delay in deployment. The detection of the position of the adjustable vehicle part by use of a position sensor, and the combination of the output signal from the position sensor with the signal from the pressure sensor, allows an accurate evaluation of the pressure signal, regardless of the position of the adjustable vehicle part. The position of, for example, a window in the vehicle door is ascertained in a particularly simple manner by use of a scale applied to the window which is scanned by a position sensor.

### BRIEF DESCRIPTION OF THE DRAWINGS

Exemplary embodiments of the present invention are explained in greater detail below, with reference to the figures.

FIG. 1 shows the block diagram of a restraint system designed according to an example embodiment of the present invention.

FIG. 2 shows the window pane of a vehicle door provided with a position sensor.

FIG. 3 shows the window pane of a vehicle door provided with a position sensor.

FIG. 4 shows a first flow diagram.

FIG. 5 shows a second flow diagram.

### DETAILED DESCRIPTION OF EXAMPLE EMBODIMENTS

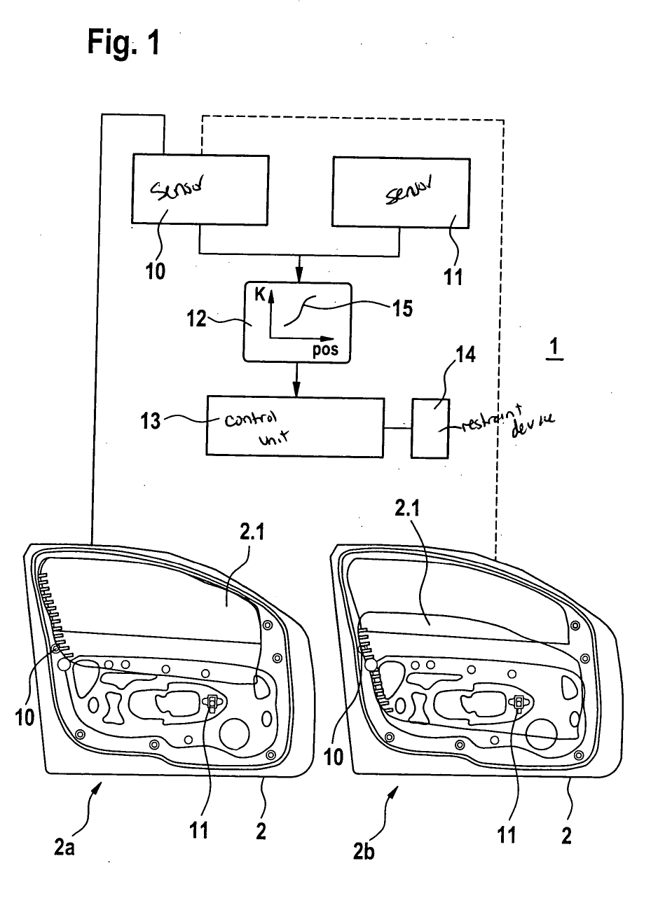

FIG. 1 shows the block diagram of a restraint system 1 designed according to the present invention. Restraint system 1 includes a control unit 13 which is connected to restraining means 14 and controls same. Restraint system 1 also includes a pressure sensor 11 which preferably is situated in the interior of a vehicle door 2. This pressure sensor 11 records pressure fluctuations generated by a side impact. Restraint system 1 also includes at least one position sensor 10 which detects the position of a movable part of the vehicle. The movable part of the vehicle is in particular a window pane 2.1 provided in vehicle door 2. The movable part of the vehicle could also be a sliding roof or the roof of a convertible, as long as the position thereof influences the output signal from pressure sensor 11. This position sensor 10 is likewise situated in the interior of vehicle door 2. In FIG. 1, window pane 2.1 is illustrated in two different positions, 2a and 2b. In position 2a, window pane 2.1 is completely closed. In position 2b, window pane 2.1 is completely open. Lastly, restraint system 1 also includes a function module 12 in which correction values K, preferably in the form of a characteristic curve 15, are stored as a function of position Pos of window pane 2.1.

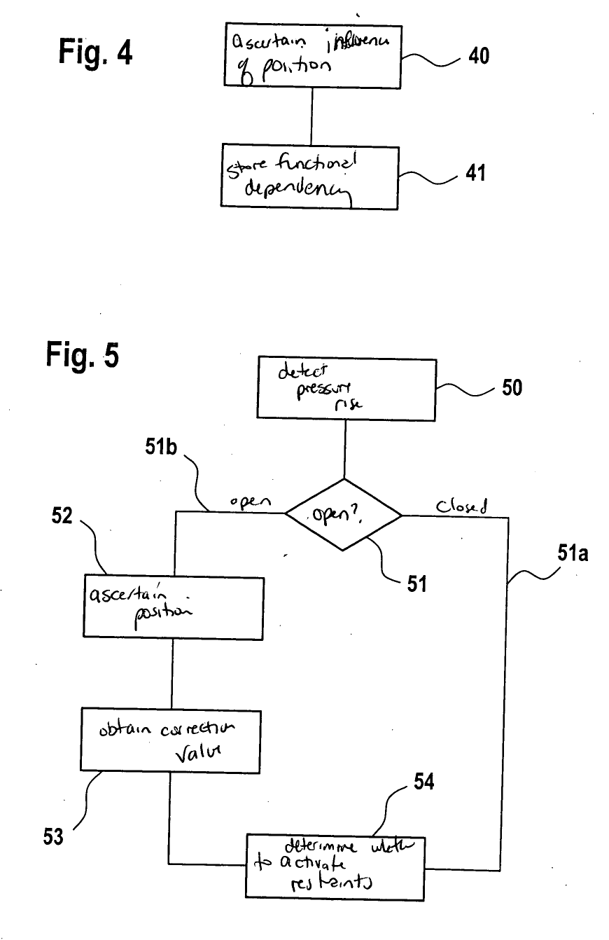

The mode of operation of restraint system 1 is explained below with reference to the flow diagrams illustrated in FIGS. 4 and 5. Firstly, a first operating phase is described, which also may be referred to as a “learning phase.” This first operating phase is explained with reference to the flow diagram illustrated in FIG. 4. In a first step 40 an ascertainment is made as to how position Pos of window pane 2.1 influences the output signal from pressure sensor 11 when a rapid pressure change, for example by compression of the volume of vehicle door 2, occurs. It is advantageous that a series of measurements is performed for each type of door, in which pressure signals from pressure sensor 11 are ascertained as a function of position Pos of window pane 2.1. Position Pos of window pane 2.1 is detected by position sensor 10. In this measurement process it is preferable to use a non-destructive method in which, for example, vehicle door 2 is acted on by the impact of a pendulum while window pane 2.1 is in different positions 2a, 2b. Besides completely closed state 2a of window pane 2.1 and completely open state 2b, any given intermediate positions may also be detected via measurements. From this series of measurements a functional dependency of the output signal from pressure sensor 11 on position Pos of window pane 2.1 may be deduced in the form of a correction value K. In a second step 41 this functional dependency is stored in function module 12 in the form of a characteristic curve 15 or discrete characteristic values.

A second operating phase of restraint system 1 which corresponds to the driving mode of the vehicle is explained below with reference to the flow diagram illustrated in FIG. 5. During driving mode, pressure sensor 11 monitors the pressure in the interior of door 2. Position sensor 10 detects position Pos of window pane 2.1. In a step 50, pressure sensor 11 detects a sudden strong pressure rise in the region of vehicle door 2. In subsequent step 51 a determination is made, based on the output signal from position sensor 10, as to whether or not window pane 2.1 is open. If window pane 2.1 is closed, the procedure branches to step 51a, which is followed by step 54. In other words, the output signal from the pressure sensor is sent unchanged to control unit 13, which then decides whether a side impact is occurring, and if necessary activates a restraint device 14 for protecting the occupants. On the other hand, if it is ascertained in step 51 that window pane 2.1 is open, the procedure branches to step 51b, which is followed by step 52. In step 52 the exact position Pos of window pane 2.1 which has been ascertained by position sensor 10 is queried. In step 53 a correction value K, which is stored in function module 12 and which is associated with this position Pos of window pane 2.1, is queried. The pressure signal from pressure sensor 11 combined with this correction value K is then sent in step 54 to control unit 13, which in turn must decide whether a hazardous side impact is occurring and whether restraining means 14 must consequently be activated. If position Pos of window pane 2.1 is known at the time of a side impact, in the event of a crash the pressure signal from pressure sensor 11 may thus be corrected according to an example embodiment of the present invention by correction value K before the signal is further processed in control unit 13. This has the advantage in particular that at the time of the calibration, the possibility of a signal reduction as a result of position Pos of window pane 2.1 must no longer be taken into account by using an additional amplitude tolerance for the signal from pressure sensor 11. A more accurate calibration is thus possible, and the deployment times remain guaranteed even in the field, since an open window pane 2.1 no longer results in a delay in deployment. In the previously described exemplary embodiment of the present invention, particular emphasis was placed on modifying the amplitude of the output signal from pressure sensor 11 as a function of position Pos of window pane 2.1 to correct the direct influence on a pressure threshold. In further embodiment variants of the present invention, other variables for correction value K may also be taken into account which may change with position Pos of window pane 2.1. In particular, this may be the full width of half maximum of the pressure signal from pressure sensor 11. Instead of a characteristic curve 15 stored in function module 12, a multidimensional characteristic map may also be used, in which, for example, the ambient temperature may also be taken into account as a correction value for the pressure signal from pressure sensor 11.

It may be advantageous to repeat the learning phase described earlier, such as within prescribed maintenance intervals for the vehicle, since differing correction values may arise as the result of aging.

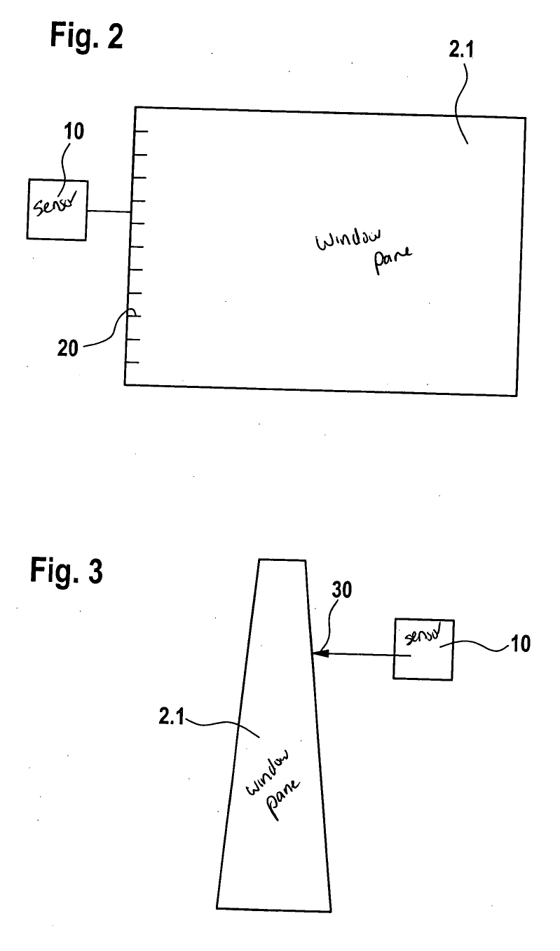

Particularly useful embodiment variants of position sensors 10 are described below, with reference to FIGS. 2 and 3. FIG. 2 shows a first embodiment variant in which window pane 2.1 bears on at least one edge a scale 20 or markings which are readable by position sensor 10. Scale 20 may either be glued to window pane 2.1, etched into the glass of window pane 2.1, or be produced using a lithographic process. Scale 20 may be linear or logarithmic. Position sensor 10 may read scale 20 absolutely or incrementally. Use may be made of proven principles in detecting the absolute position of window pane 2.1. Thus, for example, position sensor 10 may be provided with an optical scanner means for reading scale 20. However, a position sensor having inductive or capacitive scanner may also be used for scale 20 if scale 20 is appropriately designed. In one further embodiment variant, explained in greater detail with reference to FIG. 3, the position of window pane 2.1 may be determined by measuring the thickness of window pane 2.1. To this end, window pane 2.1 has a wedge-shaped design at least in one edge region, as shown by the view of a side edge of window pane 2.1 in FIG. 3. In this manner, a specified thickness of window pane 2.1 may be unambiguously associated with a defined distance from the lower or upper edge of window pane 2.1. The exact position Pos of window pane 2.1 may thus be ascertained by measuring the thickness of the window pane. To determine the thickness of window pane 2.1, position sensor 10 may be provided with, for example, a mechanical scanning element 30 which rests on the surface of window pane 2.1 in the wedge-shaped region of window pane 2.1, and, depending on the thickness of the window pane, is more or less deflected. The deflection is then preferably converted to a corresponding electrical signal by position sensor 10. In further variants, the thickness of the window pane may be scanned using an ultrasound sensor or by a interferometric device.

In an even simpler embodiment variant, use may also be made of the motion of a power window for determining the position of window pane 2.1. It is generally possible to determine position Pos of window pane 2.1 with sufficient accuracy after a single calibration operation, in which, for example, revolutions of a drive part for the power window are associated with the position of window pane 2.1.

1-13. (canceled)

14. A restraint system for a vehicle occupant, comprising:
a restraint device;
a control unit configured to control the restraint device;
at least one pressure sensor situated in a peripheral region of a vehicle; and
at least one position sensor configured to measure a position of at least one movable part of the vehicle, an output signal from the position sensor being combined with an output signal from the pressure sensor.

15. The restraint system as recited in claim 14, further comprising:
a function module in which correction values are stored as a function of the position of the movable part.

16. The restraint system as recited in claim 14, wherein the movable part is a window pane situated in the vehicle door, and the position sensor is situated in the vehicle door.

17. The restraint system as recited in claim 16, wherein the window pane is provided with a scale.

18. The restraint system as recited in claim 17, wherein the scale is at an edge region of the window pane.

19. The restraint system as recited in claim 17, wherein the scale is glued to the window pane.

20. The restraint system as recited in claim 17, wherein the scale is etched into the window pane.

21. The restraint system as recited in claim 17, wherein the scale is designed in such a way that it can be scanned by an optical device.

22. The restraint system as recited in claim 17, wherein the scale is designed in such a way that it can be scanned by one of an inductive or capacitive device.

23. The restraint system as recited in claim 16, wherein the window pane has a wedge-shaped design at least in one edge region, in such a way that a value for a thickness of the window pane can be unambiguously associated with a defined distance from one of a lower or upper edge of the window pane.

24. The restraint system as recited in claim 23, wherein the position sensor includes an arrangement configured to measure the thickness of the window pane.

25. The restraint system as recited in claim 23, wherein the position sensor includes a scanning element configured to scan the thickness of the window pane.

26. The restraint system as recited in claim 23, wherein the position sensor includes one of an optical or acoustical detector configured to detect the thickness of the window pane.

27. A method for operating a restraint system, comprising:
in a first operating phase, detecting, by a pressure sensor, pressure values as a function of a position of a movable part of a vehicle, associating correction value, with the pressure values, and storing the correction values in a functional module; and
in a second operating phase, linking the pressure values detected by the pressure sensor to correction values stored in the function module.
